(19) United States
(12) Patent Application Publication
(10) Pub. No.: US 2026/0305713 A1
(43) Pub. Date: Oct. 8, 2026

(54) AIRFLOW SENSOR-BASED ELECTRONIC CIGARETTE

(71) Applicant: ALPHASCALE TECHNOLOGIES, INC., HILLSBOROUGH, CA (US)

(72) Inventors: Lingjiao Liang, Hillsborough, CA (US); Weige Yang, Hillsborough, CA (US); Gufeng Xi, Hillsborough, CA (US)

(21) Appl. No.: 19/479,134

(22) PCT Filed: Apr. 26, 2024
(86) PCT No.: PCT/US2024/026451

§ 371 Date: Oct. 27, 2025

Related U.S. Application Data
(60) Provisional application No. 63/462,512, filed on Apr. 27, 2023.

(51) Int. Cl. A24F 40/51

(52) U.S. Cl. CPC A24F 40/51

(57) ABSTRACT

The present teachings relate to an electronic cigarette, and an airflow sensor and a circuit included in the electronic cigarette. The airflow sensor may include a fixed conductive plate, a flexible conductive film, and a spacer located between the conductive plate and the conductive film. When inhaling is from a side of the conductive film, the conductive film moves away from the conductive plate. The circuit may include an acquisition module, a selecting module, and a controlling module. The acquisition module may determine a type of the airflow sensor. The selecting module may determine a voltage value based on the type of the airflow sensor and generate a control command corresponding to the determined voltage value. The controlling module may generate a control signal. The control signal may control whether to heat aerosol forming material included in the electronic cigarette.

### CROSS REFERENCE TO RELATED APPLICATION

The present application claims priority benefit of the filing date of U.S. Provisional Patent Application No. 63/462,512, filed Apr. 27, 2023, which is herein incorporated by reference in its entirety.

### BACKGROUND

### 1. Technical Field

The present teachings generally relate to the field of electronic cigarettes. More specifically, the present teachings relate to sensors (e.g., airflow sensors) included in airflow sensor-based electronic cigarettes and electronic circuits adapted to the airflow sensor-based electronic cigarettes.

### 2. Technical Background

An electronic cigarette is an electronic device that mimics traditional cigarettes. Due to its compact size and simple usage and because its taste and usage method closely resemble traditional cigarettes, the electronic cigarette has become very popular as a new way to smoke. An electronic cigarette may include an airflow sensor, and such an electronic cigarette may be called an airflow sensor-based electronic cigarette. By detecting a change in a capacitance value of the airflow sensor, the airflow sensor-based electronic cigarette may identify whether a user is using the electronic cigarette. For example, when a user's smoking action (e.g., the user usually inhales to smoke) is detected, a control device included in the electronic cigarette may heat aerosol forming material (e.g., e-liquid, smoking oil, or the like) via a heating wire (or a heating coil) to vaporize the aerosol forming material to generate aerosol, thereby providing the user with an experience similar to that of a traditional cigarette.

However, in existing airflow sensor-based electronic cigarettes, when the aerosol forming material leaks into the airflow sensor, it may also cause change of the capacitance value that is similar to the change of the capacitance value caused by the user's smoking action discussed above. This means that the electronic cigarette cannot distinguish between accidental leakage of the aerosol forming material and the user's normal use of the electronic cigarette. Failure of distinguishing accidental leakage of the aerosol forming material from the user's normal use of the electronic cigarette may cause the aerosol forming material to be heated to generate aerosol in response to accidental leakage of the aerosol forming material, even though the electronic cigarette is not being used by the user.

Therefore, existing design of the existing electronic cigarettes has certain safety risks, such as causing spontaneous combustion during transportation or storage, leading to fires, etc. Thus, there is a need for a solution that addresses the issues identified herein.

### SUMMARY

The teachings disclosed herein relate to sensors, electronic circuits, methods, medium, device, and system associated with electronic cigarettes, and electronic cigarettes. More particularly, the present teachings relate to airflow sensors, electronic circuits adapted to airflow sensors, electronic cigarettes including airflow sensors and electronic circuits, methods of controlling electronic circuits, methods of controlling electronic cigarettes, medium storing machine-readable instructions to control electronic circuits, medium storing machine-readable instructions to control electronic cigarettes, systems controlling operations of electronic circuits, and systems controlling operations of electronic cigarettes.

According to an aspect of the present teachings, an airflow sensor is provided. The airflow sensor may include a conductive plate; a conductive film; and a spacer located between the conductive plate and the conductive film, wherein when inhaling is from a side of the conductive film, the conductive film moves away from the conductive plate.

According to another aspect of the present teachings, an electronic circuit adapted for different airflow sensors is provided. The electronic circuit may include an acquisition module configured to determine a type of an airflow sensor; a selecting module configured to determine a voltage value based on the type of the airflow sensor and to generate a control command based on the determined voltage value; and a controlling module configured to generate a control signal based on the received control command.

According to another aspect of the present teachings, a method of operating an electronic cigarette is provided. The method may include determining a type of an airflow sensor included in an electronic cigarette; determining a voltage value based on the type of the airflow sensor; generating a control command corresponding to the voltage value; and generating, based on the control command, a control signal for controlling a heating operation of the electronic cigarette.

According to another aspect of the present teachings, an apparatus is provided. The apparatus may include a sensor comprising a conductive plate, a conductive film, and a spacer located between the conductive plate and the conductive film; and an electronic circuit configured to: determine a type of the sensor, determine a voltage value based on the type of the sensor, and generate a control signal based on the voltage value.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1a illustrates an exemplary assembled structure of an airflow sensor-based electronic cigarette;

FIG. 1b illustrates an exemplary disassembled structure of an airflow sensor-based electronic cigarette;

FIG. 2a depicts a type of airflow sensor included in an airflow sensor-based electronic cigarette;

FIG. 2b depicts another type of airflow sensor included in an airflow sensor-based electronic cigarette;

FIG. 2c depicts an exemplary schematic structure of an electronic cigarette including the type of airflow sensor of FIG. 2a;

FIG. 2d depicts an exemplary schematic structure of an electronic cigarette including the type of airflow sensor of FIG. 2b;

FIG. 3a depicts an exemplary schematic structure of an electronic circuit adapted to the type of airflow sensor of FIG. 2a;

FIG. 3b depicts an exemplary schematic structure of an electronic circuit adapted to the type of airflow sensor of FIG. 2b;

FIG. 4 depicts an exemplary schematic structure of an electronic circuit adapted to both of the type of airflow sensor of FIG. 2a and the type of airflow sensor of FIG. 2b;

FIG. 5 is an exemplary flow chart of controlling the electronic circuit of FIG. 4; and

FIG. 6 depicts an exemplary system controlling an electronic cigarette.

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

To address or at least alleviate the aforementioned problems—the existing electronic cigarettes have certain safety risks due to failure to distinguish between accidental leakage of the aerosol forming material and the user's normal use of the electronic cigarette, the present invention provides a new type of airflow sensor for electronic cigarettes, as well as a new electronic circuit adapted for different airflow sensors.

For clarification purposes, the embodiments of the present teachings will be further described in detail below in conjunction with the accompanying drawings.

Unless otherwise defined, all technical and scientific terms used in this document have the same meanings as understood by those skilled in the art of the present invention. The terms used in the specification are intended to describe specific embodiments for the purpose of illustration and are not intended to limit the present invention. For example, terms such as “length,” “width,” “top,” “bottom,” “left,” “right,” “front,” “back,” “vertical,” “horizontal,” “upper,” “lower,” “inside,” and “outside” refer to directions or positions based on the orientations shown in the drawings and are merely used for convenience in description without limiting the scope of the technical solution.

The terms “comprising” and “having” and their variations in the specification and claims of the present invention, as well as in the explanations of the accompanying drawings, are intended to be non-limiting and inclusive. The terms “first,” “second,” etc., used in the specification, claims, or drawings of the present invention, are used to distinguish between different objects and are not used to describe a particular order. The term “plural” means two or more, unless otherwise specifically limited.

Furthermore, the mention of “embodiments” in this document means that specific features, structures, or characteristics described in conjunction with the embodiments can be included in at least one embodiment of the present invention. The appearance of this phrase at various locations in the specification does not necessarily refer to the same embodiment, nor is it mutually exclusive or alternative to other embodiments. Those skilled in the art explicitly and implicitly understand that the embodiments described herein can be combined with other embodiments.

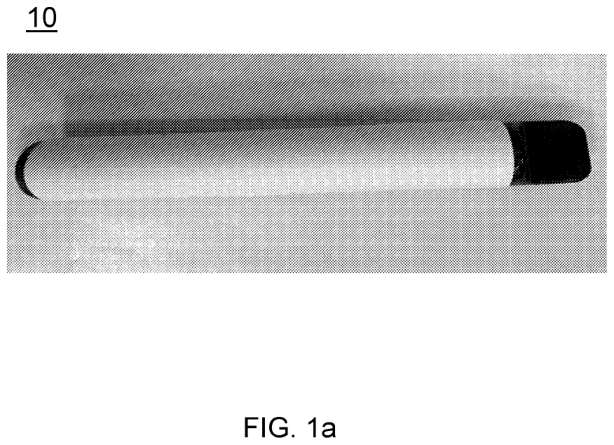

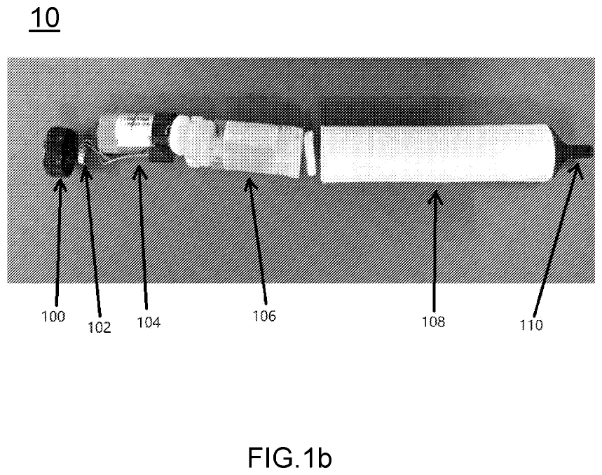

FIG. 1a illustrates an exemplary assembled structure of an airflow sensor-based electronic cigarette 10. FIG. 1b illustrates an exemplary disassembled structure of an airflow sensor-based electronic cigarette 10. As shown in FIG. 1b, the main components of the electronic cigarette include a rear cover 100, a sensor/circuit section 102, a battery 104, a cartridge 106, cigarette stem 108, and a mouthpiece 110. The cartridge 106 may contain the heating wire (or the heating coil) and the aerosol forming material. The sensor/circuit section 102 may include an airflow sensor, and a PCBA (Printed Circuit Board Assembly) with a dedicated chip (or a control chip, or a dedicated control chip) controlling operations of the electronic cigarette. In the airflow sensor-based electronic cigarette, the dedicated chip may detect a status of the airflow sensor to determine whether the user is using the airflow sensor-based electronic cigarette to smoke and control the operations of the electronic cigarette accordingly. The user may inhale or exhale from the mouthpiece 110 to smoke. The user usually inhales to start and continue smoking. In some embodiments, the user may exhale to start smoking.

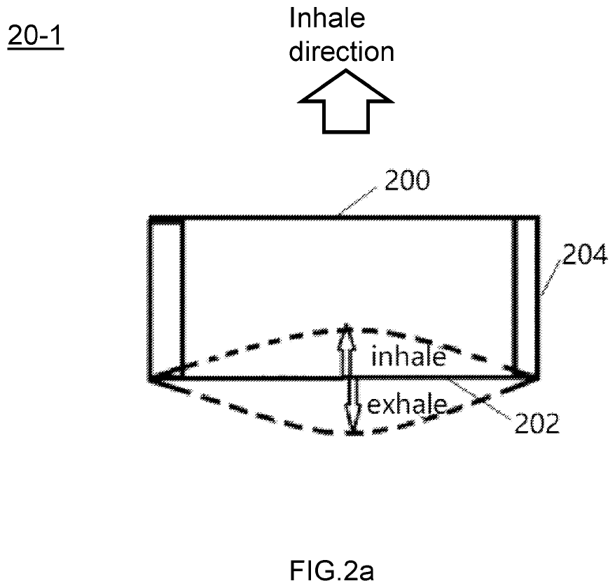

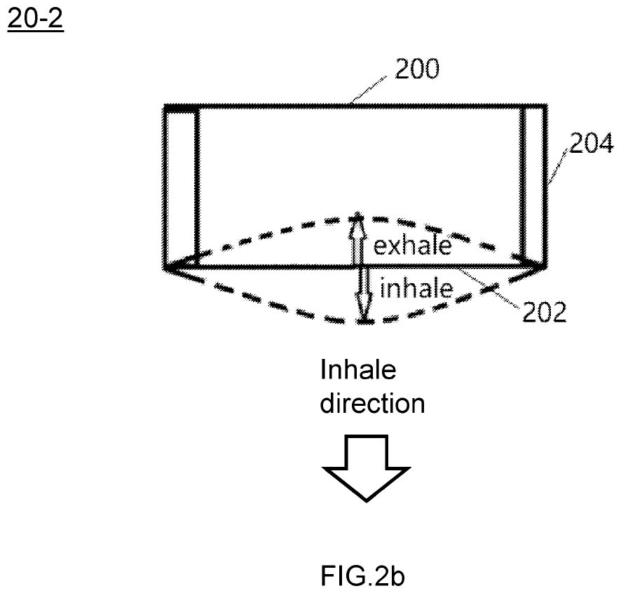

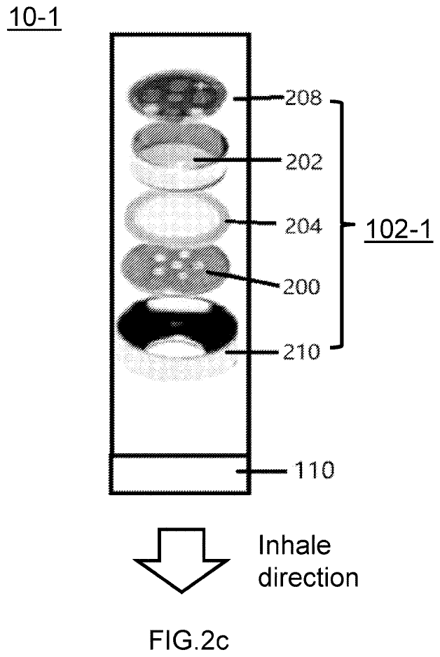

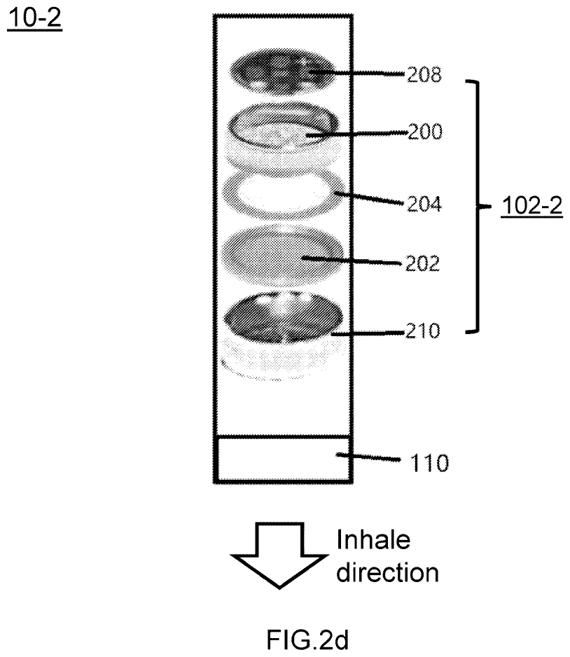

FIG. 2a depicts a type of airflow sensor 20-1 included in an airflow sensor-based electronic cigarette. The airflow sensor 20-1 may be a variable capacitor, including a conductive plate 200, a conductive film 202, and a spacer 204 located between the conductive plate 200 and the conductive film 202. The conductive plate 200 may be a fixed plate and the conductive film 202 may be a flexible film. In the absence of airflow, the distance between the conductive plate 200 and the conductive film 202 is the thickness of the spacer 204. The conductive plate 200 and conductive film 202 may be made of electrically conductive material. The spacer 204 may be made of electrically insulation material. In the presence of airflow, for example, when the user of the electronic cigarette inhales on the side of the conductive plate 200, the conductive film 202 may shift with the airflow and deform, causing a change in the distance between the conductive plate 200 and the conductive film 202. In an airflow sensor, the capacitance value is inversely proportional to the distance between the conductive plate 200 and the conductive film 202. The airflow sensor may convert the inhalation action of the user of the electronic cigarette into a change in capacitance value. The greater the strength of the inhalation (i.e., the greater the airflow change) is, the larger the displacement of the conductive film 7 in the direction closer to the conductive plate 6 is, the smaller the distance between the conductive plate 6 and the conductive film 7 is, and the greater the change in the capacitance value of the airflow sensor is. An exemplary formula to calculate the capacitance is:

$$C = ( {ε}_{r} s ) / 4 π k d \qquad ( 1 )$$

where εᵣ is the relative dielectric constant, s is the facing area between the conductive plate 200 and the conductive film 202, k is an electrostatic constant, and d is the distance between the conductive plate 200 and the conductive film 202.

Therefore, by detecting the change in the capacitance value of the airflow sensor, an electronic cigarette can determine the displacement direction and magnitude of the conductive film 204, thereby determining whether the user is inhaling or exhaling. For example, when the capacitance value of the airflow sensor increases, the electronic cigarette determines that the conductive film 204 moves towards the conductive plate 200 and thus the user is inhaling. Conversely, when the capacitance value of the airflow sensor decreases, the electronic cigarette determines that the conductive film 204 moves away from the conductive plate 200 and thus the user is exhaling.

For the airflow sensor 20-1, the user of electronic cigarettes always inhales or exhales at a side of the conductive plate 200. When the user smokes (usually indicated by inhaling), the sensor capacitance increases; when exhaling, the capacitance decreases. When the aerosol forming material leaks into the airflow sensor, the situation is similar to when the user inhales, which may also cause an increase in the capacitance value of the airflow sensor. However, the dedicated chip cannot distinguish whether the increased capacitance value is caused by normal inhalation or by leakage of aerosol forming material. This may result in the electronic cigarette's control chip being unable to differentiate leakage from the user's normal inhalation. Therefore, when the electronic cigarette detects an increase in the capacitance value of the airflow sensor, even if this capacitance change is caused by leakage of aerosol forming material, it may still send a control signal to heat the aerosol forming material. For example, it may output a high-level signal to heat the aerosol forming material. If such a situation occurs during transportation or storage, it may lead to self-ignition of the electronic cigarette, causing a fire.

Furthermore, due to a temperature coefficient of the control chip in the electronic cigarette, as the chip temperature rises, thermal drift may cause circuit parameter drift and an equivalent increase in capacitance value of the airflow sensor. This may also cause a situation where even when the user stops smoking, the output of the high-level signal to heat the aerosol forming material continues beyond the timeout protection, thereby resulting in an unstable electronic cigarette and a poor user experience.

The present teachings provide a solution to eliminate or at least alleviate such safety hazards of airflow sensor-based electronic cigarettes. FIG. 2b depicts another type of airflow sensor 20-2 included in an airflow sensor-based electronic cigarette. With the airflow sensor 20-2, the above-mentioned safety hazards may be eliminated or at least alleviated.

As shown in FIG. 2b, a user of the electronic cigarette inhales or exhales on the side of the conductive film 202, rather than on the side of the conductive plate 200 as shown in FIG. 2a. In this configuration of FIG. 2b, when the user inhales on the side of the conductive film 202, the conductive film 202 moves away from the conductive plate 200 and the capacitance value of the airflow sensor 20-2 decreases. Conversely, when exhaling, the capacitance value increases. Similar to the airflow sensor 20-1 as shown in FIG. 2a, the capacitance value of the airflow sensor 20-2 of FIG. 2b increases when there is leakage of aerosol forming material. Therefore, in the configuration of the airflow sensor 20-2 shown in FIG. 2b, the change of the capacitance value of the airflow sensor 20-2 caused by the user's inhalation is opposite to that caused by leakage of aerosol forming material. Thus, this configuration allows the control chip of the electronic cigarette to distinguish between normal inhalation by the user and leakage of aerosol forming material, thereby preventing the electronic cigarette from triggering output due to leakage of aerosol forming material. Thus, in the event of leak of aerosol forming material, the leakage will not cause self-ignition, effectively avoiding the aforementioned safety hazards. Similarly, with the airflow sensor 20-2, the parameter drift caused by high chip temperature will not result in the situation where even when the user stops inhalation, the output of the high-level signal to heat the aerosol forming material continues beyond the timeout protection.

FIG. 2c depicts an exemplary schematic structure of an electronic cigarette 10-1 including the first type of airflow sensor 20-1 of FIG. 2a. The electronic cigarette 10-1 may include a sensor/circuit section 102-1, a mouthpiece 110, and other components (not shown in FIG. 2c) that may be used in an electronic cigarette. The sensor/circuit section 102-1 may include a PCBA 208 with a dedicated chip for the electronic cigarette. The dedicated chip may include an electronic circuit (which will be discussed later) to control the electronic cigarette to heat the aerosol forming material contained in the cartridge 106. The sensor/circuit section 102-1 may also include the airflow sensor 20-1 including the conductive plate 200, the conductive film 202, and the spacer 204. The sensor/circuit section 102-1 may also include a back cover 210 to enclose and protect the airflow sensor 20-1 and PCBA 208. When the user smokes, the user inhale and exhale at the mouthpiece 110. With the electronic cigarette 10-1, the user smokes (inhales) at the side of the conductive plate 200. Configuration of the airflow sensor 20-1 is not limited to what is shown in FIG. 2c.

FIG. 2d depicts an exemplary schematic structure of an electronic cigarette 10-2 including the second type of airflow sensor 20-2 of FIG. 2b. The electronic cigarette 10-2 may include a sensor/circuit section 102-2, the mouthpiece 110, and other components (not shown in FIG. 2d) that may be used in an electronic cigarette. Compared to FIG. 2c, in electronic cigarette 10-2 in FIG. 2d, the position of the conductive plate 200 in the electronic cigarette and the position of the conductive film 202 in the electronic cigarette are swapped. With the electronic cigarette 10-2, the user inhales at the side of the conductive film 202.

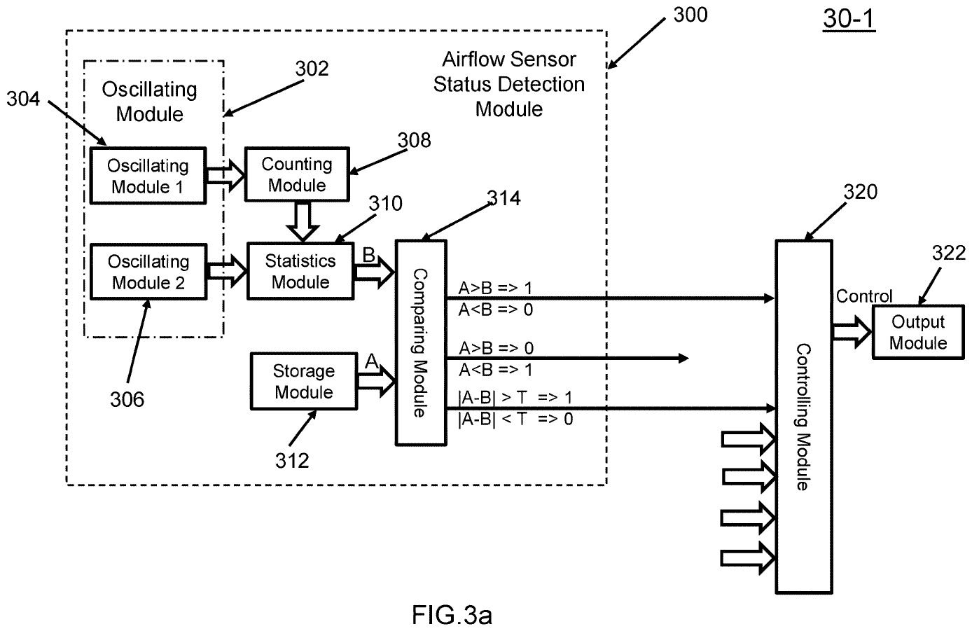

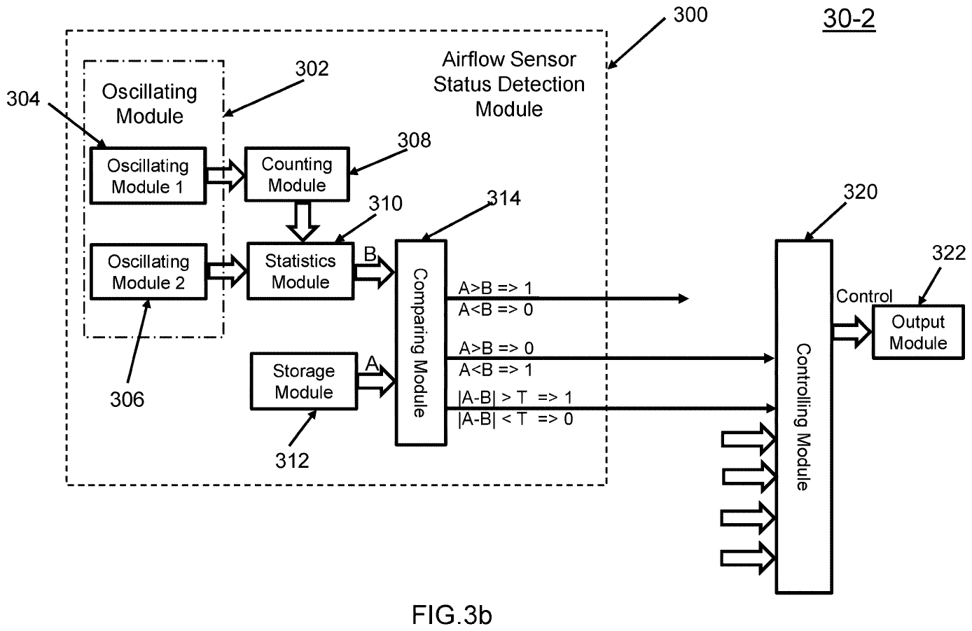

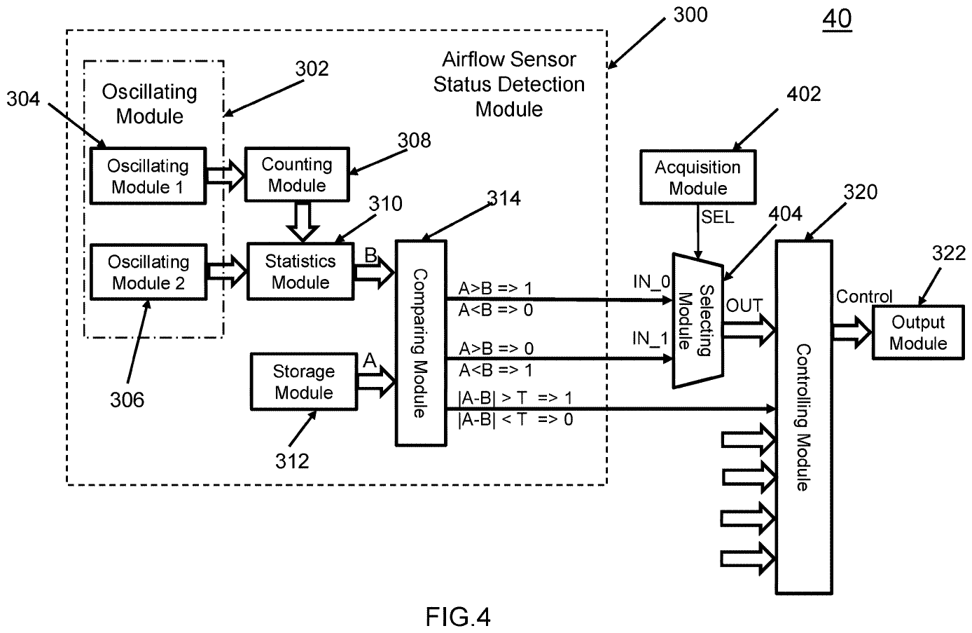

Configuration of an airflow sensor-based electronic cigarette is not limited to what is shown in FIGS. 2c and 2d. As discussed above, the dedicated chip may include an electronic circuit to control the electronic cigarette to heat the aerosol forming material contained in the cartridge 106. Different electronic circuits adapted to one or more of the first and second types of airflow sensors will be described in FIGS. 3a, 3b, and 4. FIG. 3a depicts an exemplary schematic structure of a circuit adapted to an electronic cigarette including the airflow sensor 20-1. The circuit 30-1 may include an airflow sensor status detection module 300, a controlling module 320, and an output module 322. The airflow sensor status detection module 300 may detect the status of the airflow sensor, for example, the change of the sensor capacitance. The airflow sensor status detection module 300 may include an oscillating module 302, a counting module 308, a statistics module 310, a storage module 312, and a comparing module 314.

The oscillating module 302 may be connected to the airflow sensor 20-1. The oscillating module 302 may include an oscillating module 1 304 and an oscillating module 2 306, both of which may generate oscillation cycles. The oscillating module 1 may include a fixed-frequency oscillation circuit used for timing. The oscillating module 2 may include a non-fixed-frequency oscillation circuit. The oscillating module 2 may include an input oscillation circuit for the airflow sensor 20-1. The capacitance value of the airflow sensor 20-1 determines the oscillation frequency of the oscillating module 2. When the capacitance value of the airflow sensor becomes larger, the oscillation frequency of the oscillating module 2 becomes smaller, and vice versa.

The counting module 308 may count the oscillation cycles generated by the oscillating module 1. The statistics module 310 may count the oscillation cycles generated by the oscillating module 2. When the counting module 308 counts the number of oscillation cycles of the oscillating module 1 in a certain time period, the statistics module 310 counts the number of oscillation cycles generated by the oscillating module 2 in the same time period. Thus, the counting module 308 and the statistics module 310 may work together to count the number of oscillation cycles generated by the oscillating module 2 within a certain same time period T_{c} timed by the oscillating module 1. For example, the counting module 308 may determine the time period T_{c} by counting a predetermined number of oscillation cycles of the oscillating module 1. The statistics module 310 may count and store a number of oscillation cycles generated by the oscillating module 2 within the time period T_{c}.

In some embodiments, the counting function of the counting module 308 and/or the statistics module 310 can be implemented through one or more counters. A counter may count when it receives a high-level signal. Each time a high-level signal is received, a unit value may be added to a base count and the base count may be updated. The unit value may be set to 1, and the base count may be set to 0. In some embodiments, the unit value and the base count may be any value. When a cycle change is detected in the oscillating module 1 or the oscillating module 2, a high-level signal may be sent to the one or more counters.

The storage module 312 may store a number A of oscillation cycles generated within the time period T_{c} by the oscillating module 2 when the conductive film 202 in the airflow sensor 20-1 does not have any displacement indicating that no inhaling or exhaling is detected.

As discussed above, for the airflow sensor 20-1, when the user inhales, the sensor capacitance increases; when the user exhales, the sensor capacitance decreases. As discussed above, the oscillating module 1 may be used for timing. The statistic module 310 may count a number B of cycles of the oscillating module 2 within a fixed number of cycles of the oscillating module 1 (the fixed number of cycles of the oscillating module 1 indicating the time period T_{c}). When the user inhales, the capacitance value of the airflow sensor increases, and the oscillation period of the oscillating module 2 becomes larger, resulting in a smaller count value B within the same time period.

In some embodiments, at the end of each time period T_{c}, the statistic module 310 and the storage module 312 may send the corresponding numbers of oscillation cycles within the time period T_{c} and send them to the comparing module 314. The comparing module 314 may determine the working state of the airflow sensor 20-1 based on the received numbers.

The comparison module 314 may compare the cycle numbers A and B to determine the displacement direction of the conductive film 202. If A>B, it indicates that the number of cycles of the airflow sensor 20-1 decreases during the displacement of the conductive film 202, i.e., the sensor capacitance value increases, and the displacement direction of the film 202 is towards the conductive plate 200, indicating that the user is inhaling. In this case, if a difference between A and B (i.e., |A−B|) is greater than a set threshold value T, indicating that the inhalation strength reaches a predetermined value, it is considered an effective smoking action, and the circuit may heat the heating wire, vaporizing the aerosol forming material to generate aerosol.

Conversely, if A<B, it indicates that the number of cycles increases during the displacement of the conductive film 202, i.e., the capacitance value of the airflow sensor decreases, and the displacement direction of the conductive film 202 is away from the fixed conductive plate 200, indicating that the user is exhaling. As exhaling is not considered as an effective smoking action in this example, the circuit does not heat the heating wire thus does not generate aerosol. If A=B, it is determined that the no inhaling or exhaling is detected, and the circuit does not heat the heating wire thus does not generate aerosol.

The comparison module 314 may have at least one of three outputs (from the top to bottom: a first output, a second output, and a third output). A first output is that: if A>B, outputting a high-level signal “1;” if A<B (or A=B), outputting a low-level signal “0.” A second output is that: if A>B (or A=B), outputting a low-level signal “0;” if A<B, outputting a high-level signal “1.” A third output is that: if |A−B|>T (or |A−B|=T), outputting a high-level signal “1;” if |A−B|<T, outputting a high-level signal “0.” In the embodiment as shown in FIG. 3a, the second output is not in use (not connected to the controlling module 320), and the first and third outputs are input to the controlling module 320. In some embodiments, the comparison module 314 may only have the first and third outputs and do not have the second output.

The controlling module 320 may receive signals (e.g., the first output and the third output) from the comparing module 314, generate a control signal “Control” based on the received signals, and send the control signal to the output module 322. As discussed above, the first output is that: if A>B, outputting a high-level signal “1;” if A<B (or A=B), outputting a low-level signal “0.”

If it is detected that A>B, the first output outputs a high-level signal “1” and it is determined that the user is inhaling to attempt to smoke. At this time, if it is further detected that |A−B| is greater than or equal to T, the controlling module 320 may send a control signal to an output module 322 including a MOSFET (Metal-Oxide-Semiconductor Field-Effect Transistor). The output module 322 may open the MOSFET to heat the heating wire in cartridge 106, thereby vaporizing the aerosol forming material. Conversely, if |A−B|<T, the controlling module 320 may send a control signal which does not trigger vaporization of the aerosol forming material.

If it is detected that A<B (or A=B), the first output outputs a low-level signal “0” and it is determined that the user is either exhaling or is not inhaling or exhaling at all which means the user does not attempt to smoke. When receiving the low-level signal “0,” the controlling module 320 may send out a control signal Control to the output module 322, and the output module 322 does not open the MOSFET in the output module 322 and does not trigger vaporization of the aerosol forming material in response to the control signal Control.

Thus, only when both of the first and third outputs of the computing module 314 output high-level signals “1,” the controlling module 320 may send out a control signal that controls the output module 322 to vaporize the aerosol forming material to generate aerosol.

FIG. 3b depicts an exemplary schematic structure of an electronic circuit 30-2 adapted to the electronic cigarette including the airflow sensor 20-2. The difference between FIGS. 3b and 3a is that in FIG. 3b, the first output of comparison module 314 is not in use (not connected to the controlling module 320), and the second and third outputs are input to the controlling module 320; while in FIG. 3a, the second output of comparison module 314 is not in use (not connected to the controlling module 320), and the first and third outputs are input to the controlling module 320.

As discussed above, for the airflow sensor 20-2, when the user inhales, the sensor capacitance decreases; when the user exhales, the sensor capacitance increases. For the airflow sensor 20-2, if A>B, it indicates that the number of cycles of the airflow sensor 20-2 decreases during the displacement of the conductive film 202, i.e., the sensor capacitance value increases, and the displacement direction of the film 202 is towards the conductive plate 200, indicating that the user is exhaling. If A=B, it is determined that no inhaling or exhaling is detected. In this case, the circuit does not heat the heating wire to vaporize the aerosol forming material to generate aerosol.

Conversely, if A<B, it indicates that the number of cycles increases during the displacement of the conductive film 202, i.e., the capacitance value of the airflow sensor decreases, and the displacement direction of the conductive film 202 is away from the fixed conductive plate 200, indicating that the user is inhaling. In this case, if |A−B| is greater than or equal to T, indicating that the inhalation strength reaches the predetermined value, it is considered an effective smoking action. The circuit may heat the heating wire, vaporizing the aerosol forming material to generate aerosol.

In the embodiment as shown in FIG. 3b, the first output of comparison module 314 is not in use (not connected to the controlling module 320), and the second and third outputs are input to the controlling module 320. In some embodiments, the comparison module 314 may only have the second and third outputs and do not have the first output. The controlling module 320 may receive signals (e.g., the second output and the third output) from the comparing module 314, generate a control signal “Control” based on the received signals, and send the control signal to the output module 322. A second output is that: if A>B (or A=B), outputting a low-level signal “0;” if A<B, outputting a high-level signal “1.”

If it is detected that A<B, the second output outputs a high-level signal “1.” It is determined that the user is inhaling to attempt to smoke. At this time, if it is further detected that |A−B| is greater than or equal to T, the controlling module 320 may send a control signal to an output module 322 including a MOSFET. The output module 322 may open the MOSFET such that the heating wire in cartridge 106 may be heated, thereby vaporizing the aerosol forming material to generate aerosol.

If it is detected that A>B or A=B, the second output outputs a low-level signal “0” and it is determined that the user is either exhaling or is not inhaling or exhaling at all which means the user does not attempt to smoke. When receiving the low-level signal “0,” the controlling module 320 may send out a control signal to the output module 322. In response to the control signal, the output module 322 does not open the MOSFET and does not trigger vaporization of the aerosol forming material.

Thus, only when both of the second and third outputs of the computing module 314 output high-level signals “1,” the controlling module 320 may send out a control signal that controls the output module 322 to vaporize the aerosol forming material to generate aerosol.

As an electronic cigarette may use any type of the airflow sensor 20-1 or 20-2, it is beneficial to provide an electronic circuit that may adapt to both types. In this way, an electronic cigarette equipped with such an electronic circuit may identify the type of airflow sensor (20-1 or 20-2) it contains and generate a corresponding control signal to control whether to heat the aerosol forming material to generate aerosol. Consequently, such a circuit may enable adaptive control of operation of an electronic cigarette, ensuring its normal operation. Therefore, the control chip that controls operation of an electronic cigarette is preferably adaptively modified.

FIG. 4 depicts an exemplary schematic structure of an electronic circuit 40 adapted to both types of the airflow sensor 20-1 and 20-2. As discussed above, for the airflow sensor 20-1, when the user inhales, the sensor capacitance increases; when the user exhales, the sensor capacitance decreases. For the airflow sensor 20-2, when the user inhales, the sensor capacitance decreases; when the user exhales, the sensor capacitance increases. Changes of capacitances of the two types of airflow sensors are opposite to each other when the user inhales. The circuit 40 may properly heat the aerosol forming material when the user inhales regardless the type of airflow sensors.

Compared to FIGS. 3a and 3b, FIG. 4 adds an acquisition module 402 and a selecting module 404, and both of the first and second inputs of the comparing module 314 are connected to the selecting module 404. The acquisition module 402 may determine the type of airflow sensor and output corresponding voltage level at an SEL port according to the determined type of airflow sensor.

The acquisition module 402 may determine the type of the airflow sensor via different methods. In some embodiments, the acquisition module 402 may determine the type based on whether a fuse is blown. In this scenario, different fuse states may be set for different types of airflow sensors. For example, for the first type airflow sensor 20-1, during wafer testing (a process after completion of wafer production and before chip packaging) and Circuit Probing, the Circuit Probing manufacturer may blow the fuse of the first type airflow sensor 20-1. For the second type of airflow sensor 20-2, the manufacturer does not blow the fuse. That is, during the aforementioned Circuit Probing period, the sensor type may be distinguished. If it is determined to be the first type of airflow sensor 20-1, the fuse is blown; if it is determined to be the second type of airflow sensor 20-2, the fuse is not blown. In such a setting, the acquisition module 402 may read the status of the fuse (e.g., whether it is blown or not), and determine the type of the airflow sensor used in the electronic cigarette.

In some embodiments, the acquisition module 402 may communicate with the airflow sensor. For example, an output pin of the airflow sensor may be communicatively connected to the controlling module 320. The output pin may be set to output a high-level signal if the airflow sensor is of the first type (20-1) and a low-level signal if it is of the second type (20-2). By adding the output pin for indicating the type of airflow sensor and related circuits to the airflow sensor, the acquisition module 402 may determine the type of airflow sensor used in the electronic cigarette based on the level of the signal output from this pin.

In some embodiments, after the acquisition module 402 is powered on, it may determine the type of the airflow sensor by detecting the change in the capacitance value of the airflow sensor during the user's first inhalation. When the controlling module of the electronic cigarette is powered on, if a consistent change in the capacitance value of the airflow sensor (either increasing or decreasing) is detected during the user's first inhalation within a predetermined time period (e.g., 2 seconds), and the change amount always exceeds a set threshold, an increasing capacitance value indicates the first type of airflow sensor 20-1, while a decreasing capacitance value indicates the second type of airflow sensor 20-2. In this example, the user's first action after powering on the electronic cigarette is set as the smoking action (defaulting to the user's inhalation). Based on the detected direction of the first change of capacitance value, the type of the connected airflow sensor is determined. That is, if the capacitance value increases, it is considered to be connected to the first type of airflow sensor 20-1; and if the capacitance value decreases, it is considered to be connected to the second type of airflow sensor 20-2.

The acquisition module 402 may generate control commands corresponding to the detected types of the airflow sensor. The control commands include a first control command and a second control command. For example, the first control command indicates that the airflow sensor is of the first type (e.g., 20-1), and the second control command indicates that the airflow sensor is of the second type (e.g., 20-2). When the airflow sensor is of the first type, i.e., the user of the electronic cigarette inhales or exhales at the side of the fixed conductive plate 200, the first control command is generated, and the SEL port outputs a high-level value of 1. When the airflow sensor is of the second type, i.e., the electronic cigarette user inhales or exhales at the side of the conductive film 202, the second control command is generated, and the SEL port outputs a low-level value of 0.

The selecting module 404 may select one of the input signals at IN_0 port and IN_1 port to output at the OUT port based on the signal received from the SEL port of the acquisition module 402. The selecting module 404 may receive and read the signal from the SEL port of the acquisition module 402 and output a corresponding port signal based on the received signal from the SEL port. For example, when the SEL port outputs a high-level value of 1 (indicating the first type of airflow sensor 20-1), the OUT port of the selecting module 404 outputs the value of the IN_0 port. The value of the IN_0 port corresponds to the first output of the comparison module 314 discussed above. Thus, the value of the IN_0 port is: when the capacitance value of the airflow sensor increases, the port inputs 1; otherwise, the port inputs 0.

When the SEL port outputs a low-level value of 0 (indicating the second type of airflow sensor 20-2), the OUT port of the selecting module 404 outputs the value of the IN_1 port. The value of the IN_1 port corresponds to the second output of the comparison module 314 discussed above. Thus, the value of the IN_1 port is: when the capacitance value decreases, the port inputs 1; otherwise, the port inputs 0.

When the acquisition module 402 detects the first type of airflow sensor, the SEL port may output high-level value of 1 to the selecting module 404. The selecting module 404 may select the value of the port IN_0 to be output at the OUT port. In this case, the circuit 40 may function as the circuit 30-1 as shown in FIG. 3a. For example, if it is detected that A>B, it is determined that the user is inhaling to attempt to smoke, and the OUT port outputs a high-level signal “1.” At this time, if it is further detected that |A−B| is greater than or equal to T, the controlling module 320 may send a control signal Control to the output module 322 including a MOSFET. The output module 322 may open the MOSFET such that the heating wire in cartridge 106 may be heated, thereby vaporizing the aerosol forming material. If it is detected that A<B (or A=B), it is determined that the user does not attempt to smoke, and the OUT port outputs a low-level signal “0.” When receiving the low-level signal “0,” the controlling module 320 may send out a control signal Control which does not open the MOSFET and does not trigger vaporization of the aerosol forming material.

When the acquisition module 402 detects the second type of airflow sensor, the SEL port may output high-level value of 1 to the selecting module 404. The selecting module 404 may select the value of the port IN_1 to be output at the port OUT. In this case, the circuit 40 may function as the circuit 30-2 as shown in FIG. 3b. That is, if it is detected that A<B, it is determined that the user is inhaling to attempt to smoke, and the port OUT outputs a high-level signal “1.” At this time, if it is further detected that |A−B| is greater than or equal to T, the controlling module 320 may send a control signal Control to an output module 322 including a MOSFET. The output module 322 may open the MOSFET such that the heating wire in cartridge 106 may be heated, thereby vaporizing the aerosol forming material. If it is detected that A>B or A=B, it is determined that the user does not attempt to smoke, and the port OUT outputs a low-level signal “0.” When receiving the low-level signal “0,” the controlling module 320 may send out a control signal Control which does not open the MOSFET and does not trigger vaporization of the aerosol forming material.

As such, the circuit 40 may determine the type of airflow sensor and generate proper control commands or signals to control whether to heat the aerosol forming material corresponding to the determined type. Therefore, regardless of which type of airflow sensor the electronic cigarette is equipped with, it may control the electronic cigarette to operate normally.

In some embodiments, if the user's first action is not inhalation but exhalation, then exhalation will be required to trigger smoking later on. In some embodiments, a mechanism to update the way to trigger smoking (e.g., heating the aerosol forming material to generate aerosol) is provided. The mechanism will be described as follows. If an increase in capacitance value after powering on is considered as the condition to trigger smoking, then when a decrease in capacitance value is detected continuously for more than a predetermined time period (e.g., 5 seconds) but less than a predetermined time period (e.g., 16 seconds), and returns to the static value afterward, the system may enter a state of changing the way to trigger smoking. Conversely, if a decrease in capacitance value after powering on is considered as the condition to trigger smoking, then when an increase in capacitance value is detected continuously for more than 5 seconds but less than 16 seconds, and returns to the static value afterward, the system enters the state of changing the way to trigger smoking. For example, after powering on, if the user exhales for 2 seconds as the first action, this cigarette is triggered by exhaling. If a continuous inhalation of 6 seconds is detected, then if the next inhalation lasts for more than 2 seconds, this cigarette may change the way to trigger smoking and becomes be triggered by inhalation.

In some embodiments, when exhalation triggers smoking, the electronic circuits may be configured to operate differently compared to when inhalation triggers smoking discussed above. For example, when it is determined to be the first type of airflow sensor, if it is detected that A>B (or A=B), it is determined that the user is inhaling or not inhaling or exhaling at all so not attempting to smoke, and the OUT port may output a low-level signal “0.” When receiving the low-level signal “0,” the controlling module 320 may send out a control signal Control which does not open the MOSFET and does not trigger vaporization of the aerosol forming material. If it is detected that A<B, it is determined that the user is exhaling to attempt to smoke, and the OUT port may output a high-level signal “1.” At this time, if it is further detected that |A−B| is greater than or equal to T, the controlling module 320 may send a control signal Control to the output module 322. The output module 322 may open the MOSFET such that the heating wire in cartridge 106 may be heated, thereby vaporizing the aerosol forming material.

As another example, when it is determined to be the second type of airflow sensor, if it is detected that A<B (or A=B), it is determined that the user is inhaling or not inhaling or exhaling at all so not attempting to smoke, and the OUT port outputs a low-level signal “0.” When receiving the low-level signal “0,” the controlling module 320 may send out a control signal Control which does not open the MOSFET and does not trigger vaporization of the aerosol forming material. If it is detected that A>B, it is determined that the user is exhaling to attempt to smoke, and the port OUT outputs a high-level signal “1.” At this time, if it is further detected that |A−B| is greater than or equal to T, the controlling module 320 may send a control signal Control to an output module 322. The output module 322 may open the MOSFET such that the heating wire in cartridge 106 may be heated, thereby vaporizing the aerosol forming material.

In some implementations, the circuits shown in FIGS. 3a, 3b, and 4 may be integrated into the dedicated control chip.

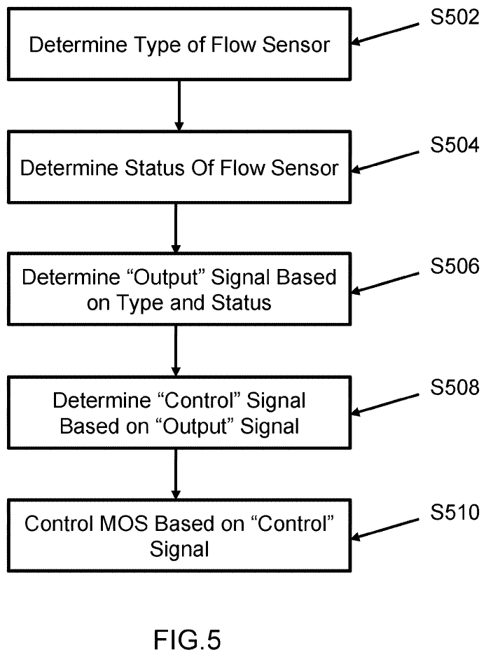

FIG. 5 is an exemplary flow chart of controlling the electronic circuit of FIG. 4. The electronic cigarette may include an airflow sensor and a dedicated control chip. The method may be implemented on the dedicated control chip. The method may include the following steps S502-S510:

Step S502: Determining the type of the airflow sensor. For example, the airflow sensor may be either the first type 20-1 or the second type 20-2. This step may be realized by the acquisition module 402 as discussed above.

Step S504: Determining the operating status of the electronic cigarette. The operation status may include determining the status of the airflow sensor. In some embodiments, determining the operating status of the electronic cigarette may include: obtaining the change in the capacitance value of the airflow sensor within a predetermined time; determining the change amount of the capacitance value based on the change in capacitance value; comparing the change amount of the capacitance value with a predetermined threshold; and determining the operating status of the electronic cigarette based on the comparison result. This step may be realized by the airflow sensor status detection module 300 as discussed above.

Step S506: Determining the output level value based on the type of the airflow sensor and the operating status of the airflow sensor. The output level value may be the value of the OUT port. This step may be realized by the selecting module 404 as discussed above.

Step S508: Generating control commands corresponding to the determined output level value. The control commands may be the control signal “Control.” This step may be realized by the controlling module 320 as discussed above.

Step S510: Controlling the MOS based on the control commands. This step may be realized by the output module 322 as discussed above.

The present teachings also provide a storage medium, on which machine-readable instructions controlling the above discussed circuits are stored. The machine-readable instructions may be executed by a processor to effectuate operational steps (e.g., one or more of steps S502-S510). The circuits may be integrated on a dedicated control chip for an electronic cigarette adapted for different airflow sensors. When the dedicated control chip for the electronic cigarette is executed by a processor, the steps (e.g., one or more of steps S502-S510) of adapting the dedicated control chip for the electronic cigarette to different airflow sensors as previously described are implemented. Since the storage medium adopts all the technical solutions of the above embodiments, it possesses at least all the beneficial effects brought by the technical solutions of the embodiments mentioned above, which will not be reiterated here.

The storage medium may be a machine-readable medium. The machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution. Tangible non-transitory “storage” type media include any or all of the memory or other storage for the computers, processors or the like, or associated modules thereof, such as various semiconductor memories, tape drives, disk drives and the like, which may provide storage at any time for the software programming.

The present teachings also provide an electronic device or system which includes one or more memories and one or more processors. The memory may store one or more machine-readable instructions. The processor may load and execute the one or more machine-readable instructions to control the electronic circuit of the dedicated control chip for the electronic cigarette adapted for different airflow sensors as discussed previously.

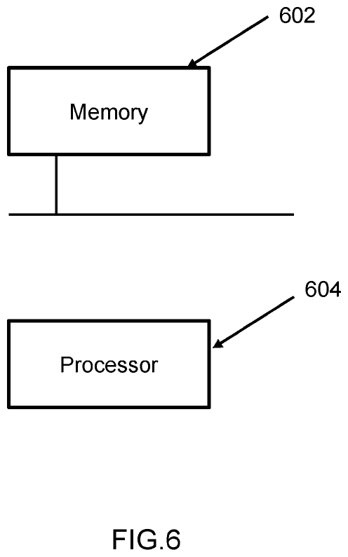

FIG. 6 illustrates an exemplary electronic device or system. As shown in FIG. 6, the memory 602 and the processor 604 may be connected via a bus. The bus may include any number of interconnected buses and bridges, connecting various circuits of one or more processors 604 and one or more memories 602 together. The bus can also connect various other circuits such as peripheral devices, stabilizers, and power management circuits, which are well known in the art, and therefore, will not be further described herein. A bus interface may provide an interface between the bus and transceivers. The transceiver may be a single component or multiple components, such as multiple receivers and transmitters, providing units for communicating with various other devices on the transmission medium. Data processed by the processor 604 may be transmitted on a wireless medium via an antenna. Furthermore, the antenna also receives data and transfers the data to the processor 604.

The processor 604 may manage the bus and general processing, and can also provide various functions, including timing, peripheral interfaces, voltage regulation, power management, and other control functions. The memory 602 may store data used by the processor 604 during execution. In some embodiments, the data may include machine-readable instructions that may be executed by the processor 604 to effectuate operational steps (e.g., one or more of steps S502-S510).

The various technical solutions described in the present invention may eliminate or at least alleviate the safety hazards of existing airflow sensor-type electronic cigarettes, thereby enhancing safety and stability during transportation, use, and other processes.

The teachings disclosed herein relate to sensors, electronic circuits, methods, medium, device, and system associated with electronic cigarettes, and electronic cigarettes. More particularly, the present teachings relate to airflow sensors, electronic circuits adapted to airflow sensors, electronic cigarettes including airflow sensors and electronic circuits, methods of controlling electronic circuits, methods of controlling electronic cigarettes, medium storing machine-readable instructions to control electronic circuits, medium storing machine-readable instructions to control electronic cigarettes, systems controlling operations of electronic circuits, and systems controlling operations of electronic cigarettes.

According to an aspect of the present teachings, an airflow sensor is provided. The airflow sensor may include a fixed conductive plate, a flexible conductive film, and a spacer located between the conductive plate and the conductive film. When inhaling is from a side of the conductive film, the conductive film moves away from the conductive plate. When exhaling is from a side of the conductive film, the conductive film moves towards the conductive plate.

According to another aspect of the present teachings, an electronic circuit adapted for different airflow sensors is provided. The electronic circuit may be integrated into a dedicated control chip. The electronic circuit may include an acquisition module, a selecting module, and a controlling module. The acquisition module may determine a type of the airflow sensor. The selecting module may determine a voltage value based on the type of the airflow sensor and generate a control command corresponding to the determined voltage value. The controlling module may generate a control signal. The control signal may control whether to heat aerosol forming material.

In some embodiments, the control command may include a first control command and a second control command. The first control command may correspond to a first type of airflow sensor. The second control command may correspond to a second type of airflow sensor.

In some embodiments, the first type of airflow sensor is an airflow sensor for inhaling or exhaling from the side of the conductive plate. The second type of airflow sensor is an airflow sensor for inhaling or exhaling from the side of the conductive film.

In some embodiments, the electronic circuit may further include an oscillating module. The oscillating module may include a first oscillation circuit and a second oscillation circuit both of which may generate oscillation periods. The first oscillation circuit may be a fixed-frequency oscillation circuit used as a timing reference clock. The second oscillation circuit may be a non-fixed frequency oscillation circuit.

In some embodiments, the electronic circuit may further include a counting module and a comparing module. The counting module may count the oscillation periods generated by the first oscillation circuit and the second oscillation circuit, respectively. The comparing module may determine a working state of the airflow sensor based on the counting of the counting module.

In some embodiments, the working state may be a working state of the airflow sensor under inhalation and/or exhalation action of a user of an electronic cigarette.

In some embodiments, the circuit may further include a storage module. The storage module may store information associated with the counting.

In some embodiments, the control signal may control whether to heat aerosol forming material.

According to another aspect of the present teachings, a method of controlling an electronic circuit adapted for different airflow sensors is provided. The method may include steps of: determining a type of an airflow sensor; determining a voltage value based on the type of the airflow sensor; generating a control command corresponding to the determined voltage value; and generating a control signal based on the received control command.

According to another aspect of the present teachings, a method of controlling an electronic cigarette. The method may include steps of: determining a type of an airflow sensor included in the electronic cigarette; determining a voltage value based on the type of the airflow sensor; generating a control command corresponding to the determined voltage value; and generating a control signal based on the received control command to control a heating operation of the electronic cigarette.

In some embodiments, determining the type of the airflow sensor may include steps of: obtaining a change in a capacitance value of the airflow sensor within a predetermined time, comparing the change in the capacitance value with a predetermined threshold, and determining the type of the airflow sensor based on the comparison result.

In some embodiments, the type of airflow sensor may be a first type for inhaling or exhaling from the side of the fixed conductive plate side, or a second type for inhaling or exhaling from the side of the flexible conductive film.

According to another aspect of the present teachings, a computer-readable storage medium is provided. The computer-readable storage medium may store one or more machine-readable instructions. The machine-readable instructions may be executed by a processor to effectuate operational steps to control the electronic circuit adapted for different airflow sensors as described above.

According to another aspect of the present teachings, an electronic device is provided. The electronic device may include: a memory and a processor. The memory may store at least one program instruction. The processor may load and execute the at least one program instruction to control the electronic circuit adapted for different airflow sensors as described above.

According to another aspect of the present teachings, an electronic cigarette is provided. The electronic cigarette may include any type of different airflow sensors as described above and an electronic circuit adapted to any type of airflow sensor as described above.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. An airflow sensor, comprising:
a conductive plate;
a conductive film; and
a spacer located between the conductive plate and the conductive film, wherein
when inhaling is from a side of the conductive film, the conductive film moves away from the conductive plate.

2. The airflow sensor of claim 1, wherein when exhaling is from the side of the conductive film, the conductive film moves towards the fixed conductive plate.

3. The airflow sensor of claim 1, wherein the conductive plate is fixed and the conductive film is flexible.

4. An electronic circuit, comprising:
an acquisition module configured to determine a type of an airflow sensor;
a selecting module configured to determine a voltage value based on the type of the airflow sensor and to generate a control command based on the determined voltage value; and
a controlling module configured to generate a control signal based on the received control command.

5. The electronic circuit of claim 4, wherein the control command comprises a first control command and a second control command.

6. The electronic circuit of claim 5, wherein the first control command corresponds to a first type of airflow sensor; and the second control command corresponds to a second type of airflow sensor.

7. The electronic circuit of claim 6, wherein the first type of airflow sensor comprises a fixed conductive plate, a flexible conductive film, and a spacer located between the fixed conductive plate and the flexible conductive film, and
the first type of airflow sensor is an airflow sensor for inhaling or exhaling from a side of the fixed conductive plate.

8. The electronic circuit of claim 6, wherein the first type of airflow sensor comprises a fixed conductive plate, a flexible conductive film, and a spacer located between the fixed conductive plate and the flexible conductive film, and
the second type of airflow sensor is an airflow sensor for inhaling or exhaling from a side of the flexible conductive film.

9. The electronic circuit of claim 4, further comprising:
an oscillating module comprising a first oscillation circuit that is a fixed-frequency oscillation circuit to generate a timing reference clock, and
a second oscillation circuit that is a non-fixed frequency oscillation circuit.

10. The electronic circuit of claim 4, further comprising:
a counting module configured to count the oscillation periods generated by the first oscillation circuit and the second oscillation circuit, respectively; and
a comparison module configured to determine a working state of the airflow sensor based on the counting of the counting module.

11. The electronic circuit of claim 10, wherein the working state is a working state of an airflow sensor under inhalation and/or exhalation of a user of an electronic cigarette including the airflow sensor.

12. The electronic circuit of claim 10, further comprising:
a storage module configured to store information associated with the counting.

13. The electronic of claim 4, wherein the control signal controls whether to heat aerosol forming material.

14. A method of operating an electronic cigarette, the method comprising:
determining a type of an airflow sensor included in an electronic cigarette;
determining a voltage value based on the type of the airflow sensor;
generating a control command corresponding to the voltage value; and
generating, based on the control command, a control signal for controlling a heating operation of the electronic cigarette.

15. The method of claim 14, wherein the determining the type of the airflow sensor comprises:
obtaining, within a predetermined time, a change in a capacitance value of the airflow sensor;
comparing the change in the capacitance value with a predetermined threshold; and
determining the type of the airflow sensor based on the comparing.

16. The method of claim 14, wherein the type of airflow sensor is a first type for inhaling or exhaling from a side of a fixed conductive plate of an airflow sensor, or a second type for inhaling or exhaling from a side of a flexible conductive film of an airflow sensor.

17. The method of claim 14, wherein the control signal controls whether to heat aerosol forming material.

18. An apparatus, comprising:
a sensor comprising a conductive plate, a conductive film, and a spacer located between the conductive plate and the conductive film; and
an electronic circuit configured to:
determine a type of the sensor,
determine a voltage value based on the type of the sensor, and
generate a control signal based on the voltage value.

19. The apparatus of claim 18, wherein the type of sensor may be a first type for inhaling or exhaling from a side of the conductive plate, or a second type for inhaling or exhaling from a side of the conductive film.

20. The apparatus of claim 18, wherein the control signal controls whether to heat aerosol forming material included in the apparatus.
